(19) United States
(12) Patent Application Publication
(10) Pub. No.: US 2011/0293192 A1
(43) Pub. Date: Dec. 1, 2011

(54) IMAGE PROCESSING APPARATUS AND METHOD, AND PROGRAM

(76) Inventor: Hideyuki ICHIHASHI, TOKYO (JP)

(21) Appl. No.: 13/114,938

(22) Filed: May 24, 2011

(30) Foreign Application Priority Data
Jun. 1, 2010 (JP) P2010-125969

(51) Int. Cl. G06K 9/48

(52) U.S. Cl. 382/199

(57) ABSTRACT

An image processing apparatus includes a boundary detection unit, a correlation value calculation unit, and a region detection unit. The boundary detection unit detects an inner boundary and an outer boundary in each of local regions in an image including an object and a background. The inner boundary is a boundary between the object and the background when viewed from the object, and the outer boundary is a boundary between the object and the background when viewed from the background. The correlation value calculation unit calculates a spatial correlation value between the inner boundary and the outer boundary for each of the local regions. The region detection unit detects a local region having a correlation value less than or equal to a certain threshold among the local regions.

### BACKGROUND

The present disclosure relates to an image processing apparatus and method, and a program, and more specifically to an image processing apparatus and method, and a program suitable for use in image blur estimation.

Techniques of image blur estimation using alpha maps (α maps) have been proposed (see, for example, Shenyang Da and Ying Wu, “Motion from blur”, IEEE CVPR, 2008).

An α map is an image (map) in which an α value is set for each unit region of a certain size (for example, for each pixel or each block of m pixels×n pixels) in an image including, for example, an object (foreground) and a background to separate the object and the background from each other. For example, the α value of a unit region included only in the object is set to a maximum value (for example, 1), and the α value of a unit region included only in the background is set to a minimum value (for example, 0). Further, the α value of an object-and-background-blended unit region, that is, a unit region included in both the object and the background, is set to an intermediate value between the maximum value and the minimum value (for example, 0<α<1). The intermediate value is set in accordance with the ratio of the object area to the background area in the unit region.

A unit region whose α value is set to an intermediate value and a region including unit regions whose α values are set to intermediate values are hereinafter referred to as “intermediate regions”.

For example, in an α map for a blurred image caused by movement of the image capturing device or movement of the object, an intermediate region having a length corresponding to the duration of movement in the direction of the movement appears in boundaries between the object and the background. The gradient information on the α value or α values of the intermediate region may be used to estimate parameters related to image blur.

### SUMMARY

Blur estimation of the related art using α maps is based on the assumption that intermediate regions are caused by image blur. In actuality, however, all intermediate regions are not caused only by image blur. Intermediate regions caused by other factors will be described with reference to FIGS. 1 and 2.

FIGS. 1 and 2 are diagrams of α maps for photographed images of an object 1, which are represented by monochrome images. In the α maps illustrated in FIGS. 1 and 2, a unit region whose α value is set to the minimum value is represented in black, and a unit region whose α value is set to the maximum value is represented in white, where a unit region having a larger α value is lighter. FIG. 1 illustrates an example of an α map obtained when the original image is an unblurred image, and FIG. 2 illustrates an example of an α map obtained when the original image is a blurred image.

The α map illustrated in FIG. 1 has areas 11 and 12 in which portions smaller than the width of unit regions, such as hair portions, exist near the edges of the object 1. In the areas 11 and 12, consequently, portions whose α values are set to intermediate values, that is, intermediate regions, occur near the edges of the object 1 although no image blur has occurred.

A region corresponding to a portion (such as head hair or animal fur) finer than a unit region near an edge of an object is hereinafter referred to as a “fuzzy region”. Among α value components, components produced by a fuzzy region are hereinafter referred to as “fuzzy components” and components produced due to image blur are hereinafter referred to as “blur components”.

Therefore, in the blur estimation based on the α map illustrated in FIG. 1 using a method of the related art, the fuzzy components contained in the intermediate regions in the areas 11 and 12 may become noise, resulting in low accuracy of blur estimation. That is, an image blur detection error may occur.

In the α map illustrated in FIG. 2, in contrast, due to the image blur, portions whose α values are set to intermediate values, i.e., intermediate regions, occur near the edges of the object 1 in areas 21 to 23 in addition to the areas 11 and 12. The intermediate regions in the areas 11 and 12 contain both fuzzy components and blur components, and the intermediate regions in the areas 21 to 23 contain only blur components.

Therefore, in the blur estimation based on the α map illustrated in FIG. 2 using a method of the related art, similarly to the blur estimation based on the α map illustrated in FIG. 1, the fuzzy components contained in the intermediate regions in the areas 11 and 12 may become noise, resulting in low accuracy of blur estimation. That is, the errors in magnitude and direction of estimated image blur may be large.

It is desirable to provide high-accuracy image blur estimation.

According to an embodiment of the present disclosure, an image processing apparatus includes a boundary detection unit, a correlation value calculation unit, and a region detection unit. The boundary detection unit is configured to detect an inner boundary and an outer boundary in each of local regions in an image including an object and a background. The inner boundary is a boundary between the object and the background when viewed from the object, and the outer boundary is a boundary between the object and the background when viewed from the background. The correlation value calculation unit is configured to calculate a spatial correlation value between the inner boundary and the outer boundary for each of the local regions. The region detection unit is configured to detect a local region having a correlation value less than or equal to a certain threshold among the local regions.

The image processing apparatus may further include a blur estimation unit configured to estimate image blur in an estimation-target region that is a region other than the local region detected by the region detection unit.

The image processing apparatus may further include a sample point setting unit configured to set a sample point to be processed for blur estimation in the estimation-target region, and a division unit configured to divide the image into n blocks. The blur estimation unit may include n block blur estimation units each configured to estimate image blur in one of the blocks, and an image blur estimation unit configured to estimate overall blur in the image in accordance with estimation results of image blur in the blocks.

The division unit may divide the image into n blocks so that the numbers of sample points included in the blocks become substantially uniform.

The division unit may allocate the blocks to the block blur estimation units in accordance with processing capabilities of the block blur estimation units and the number of sample points included in each of the blocks.

The image may be an alpha map in which a first value, a second value, or an intermediate value between the first value and the second value is set for each unit region having a certain size in an original image in such a manner that the first value is set for a unit region included only in the object, the second value is set for a unit region included only in the background, and the intermediate value is set for a unit region included both in the object and the background in accordance with a ratio of an area of the object to an area of the background in the unit region.

According to an embodiment of the present disclosure, an image processing method for an image processing apparatus includes detecting an inner boundary and an outer boundary in each of local regions in an image including an object and a background, the inner boundary being a boundary between the object and the background when viewed from the object, the outer boundary being a boundary between the object and the background when viewed from the background; calculating a spatial correlation value between the inner boundary and the outer boundary for each of the local regions; and detecting a local region having a correlation value less than or equal to a certain threshold among the local regions.

According to an embodiment of the present disclosure, a program causes a computer to execute a process including detecting an inner boundary and an outer boundary in each of local regions in an image including an object and a background, the inner boundary being a boundary between the object and the background when viewed from the object, the outer boundary being a boundary between the object and the background when viewed from the background; calculating a spatial correlation value between the inner boundary and the outer boundary for each of the local regions; and detecting a local region having a correlation value less than or equal to a certain threshold among the local regions.

In an embodiment of the present disclosure, an inner boundary that is a boundary between an object and a background when viewed from the object and an outer boundary that is a boundary between the object and the background when viewed from the background are detected in each of local regions in an image; a spatial correlation value between the inner boundary and the outer boundary is calculated for each of the local regions; and a local region having a correlation value less than or equal to a certain threshold is detected among the local regions.

According to an embodiment of the present disclosure, a fuzzy region can be detected. Consequently, according to an embodiment of the present disclosure, the accuracy of image blur estimation can be increased.

### BRIEF DESCRIPTION OF THE DRAWINGS

FIG. 1 is a diagram illustrating an example of an α map for an unblurred image;

FIG. 2 is a diagram illustrating an example of an α map for a blurred image;

FIG. 3 is a block diagram illustrating an example configuration of an image processing apparatus according to a first embodiment of the present disclosure;

FIG. 4 is a diagram illustrating an overview of a fuzzy region detection method;

FIG. 5 is a diagram illustrating an overview of a fuzzy region detection method;

FIG. 6 is a diagram illustrating an overview of a fuzzy region detection method;

FIG. 7 is a diagram illustrating an overview of a fuzzy region detection method;

FIG. 8 is a diagram illustrating an α map division method;

FIG. 9 is a diagram illustrating an α map division method;

FIG. 10 is a diagram illustrating an α map division method;

FIG. 11 is a flowchart illustrating a blur estimation process;

FIG. 12 is a diagram illustrating a specific example of a fuzzy region detection method;

FIG. 13 is a diagram illustrating a specific example of a fuzzy region detection method;

FIG. 14 is a diagram illustrating a specific example of an α map division method;

FIG. 15 is a block diagram illustrating an example configuration of an image processing apparatus according to a second embodiment of the present disclosure;

FIG. 16 is a flowchart illustrating a blur estimation process;

FIG. 17 is a diagram illustrating a specific example of an α map division method;

FIG. 18 is a diagram illustrating another specific example of a fuzzy region detection method; and

FIG. 19 is a block diagram illustrating an example configuration of a computer.

### DETAILED DESCRIPTION OF EMBODIMENTS

Exemplary embodiments of the present disclosure (hereinafter referred to as “embodiments”) will be described. The description will be given in the following order:

1. First embodiment (an example of dividing an image into blocks, each of which is the unit of blur estimation, so that the numbers of sample points included in the blocks become substantially uniform)

2. Second embodiment (an example of allocating blocks, each of which is the unit of blur estimation, in accordance with the processing capabilities of block blur estimation units)

3. Modifications

### First Embodiment

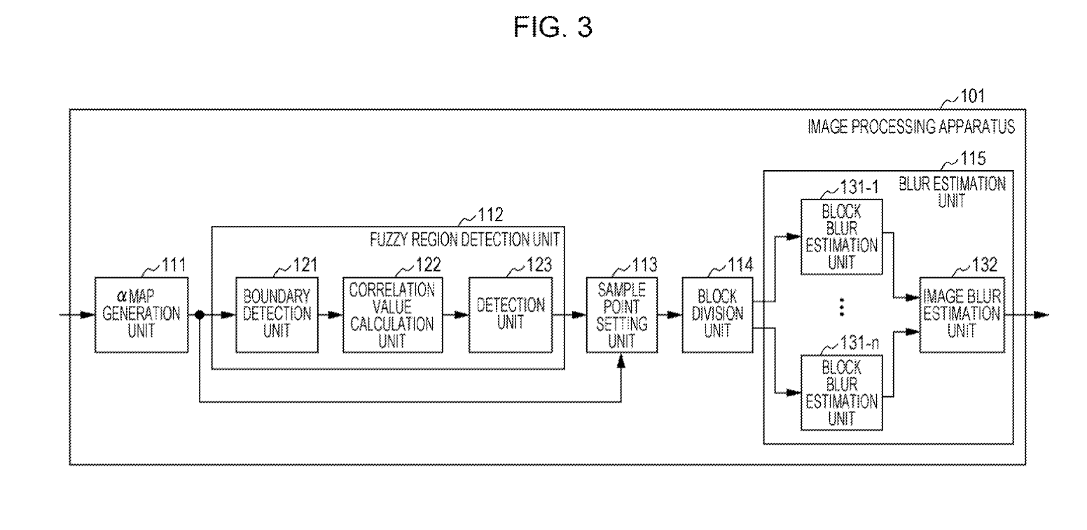

A first embodiment of the present disclosure will be described with reference to FIGS. 3 to 14.

FIG. 3 is a block diagram illustrating an example configuration of an image processing apparatus 101 according to a first embodiment of the present disclosure.

The image processing apparatus 101 includes an α map generation unit 111, a fuzzy region detection unit 112, a sample point setting unit 113, a block division unit 114, and a blur estimation unit 115.

The α map generation unit 111 generates an α map for an input image, and supplies the α map to a boundary detection unit 121 of the fuzzy region detection unit 112 and to a sample point setting unit 113.

In the following description, for ease of description, it is assumed that a unit region based on which an α map is generated has a size of 1 pixel×1 pixel. That is, it is assumed that one α value is determined for each pixel of the input image and an α map is generated. Further, the unit region in the α map corresponding to each pixel of the input image is hereinafter also referred to as the “pixel”. It is also assumed that the α map has α values in the range of 0≦α≦1 and an α value corresponding to the object is set to 1 while an α value corresponding to the background is set to 0.

The fuzzy region detection unit 112 includes the boundary detection unit 121, a correlation value calculation unit 122, and a detection unit 123.

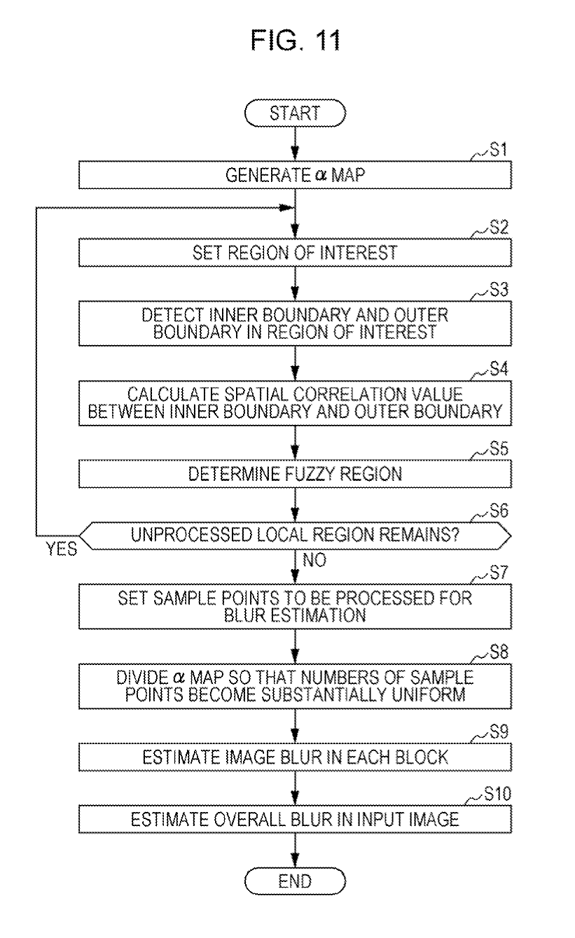

As described below with reference to FIG. 11 and the like, the boundary detection unit 121 detects, based on the α map, a boundary (hereinafter referred to as an “inner boundary”) between the object and the background when viewed from the object and a boundary (hereinafter referred to as an “outer boundary”) between the object and the background when viewed from the background. The boundary detection unit 121 supplies the detected inner boundary and outer boundary to the correlation value calculation unit 122.

As described below with reference to FIG. 11 and the like, the correlation value calculation unit 122 calculates a spatial correlation value between the inner boundary and the outer boundary for each local region having a certain size in the α map. The correlation value calculation unit 122 supplies the calculated correlation values to the detection unit 123.

As described below with reference to FIG. 11 and the like, the detection unit 123 detects a fuzzy region on the basis of the correlation values of the respective local regions. The detection unit 123 supplies the detected fuzzy region to the sample point setting unit 113.

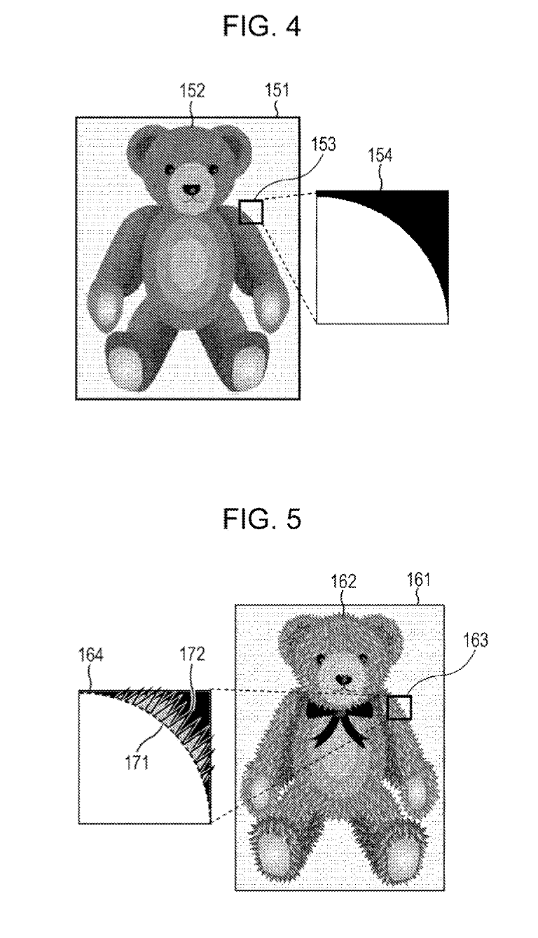

An overview of a fuzzy region detection method performed by the fuzzy region detection unit 112 will be described with reference to FIGS. 4 to 7.

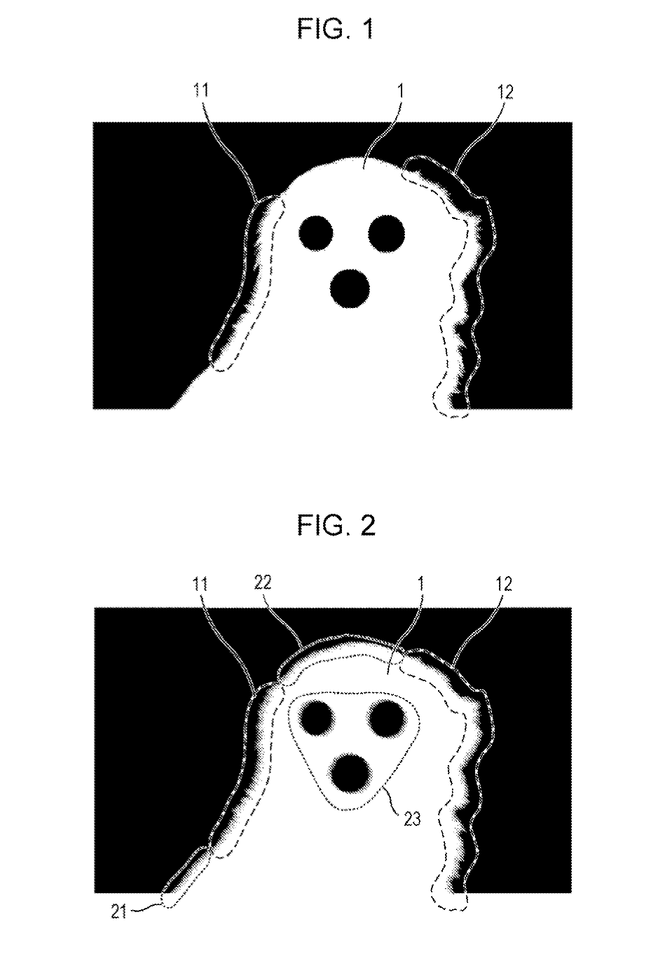

FIG. 4 illustrates an example of an α map 154 for a region 153 near the edge of an object 152 in an image 151, which is represented by a monochrome image in a manner similar to those in FIGS. 1 and 2. Since the region 153 has no fuzzy region near the edge of the object 152, the boundaries between the object 152 and the background are clear and sharp in the α map 154. In the α map 154, therefore, the shape of the inner boundaries when viewed from the object 152 and the shape of the outer boundaries when viewed from the background substantially match. Accordingly, the spatial correlation between the inner boundaries and the outer boundaries is high in the non-fuzzy regions.

FIG. 5 illustrates an example of an α map 164 for a region 163 near the edge of an object 162 in an image 161, which is represented by a monochrome image in a manner similar to those in FIGS. 1 and 2. The body of the object 162 is covered with hair fur, and regions near the edges of the object 162 in the region 163 become fuzzy regions where the boundaries between the object 162 and the background are vague. Therefore, in the α map 164, the shape of an inner boundary 171 when viewed from the object 162, which is indicated by a dotted line, and the shape of an outer boundary 172 when viewed from the background, which is indicated by a solid line, are markedly different from each other. Accordingly, the spatial correlation between the inner boundaries and the outer boundaries is low in the fuzzy regions.

Thus, a fuzzy region can be detected by focusing attention on the degree to which the shape of an inner boundary and the shape of an outer boundary match, that is, focusing attention on the spatial correlation between an inner boundary and an outer boundary.

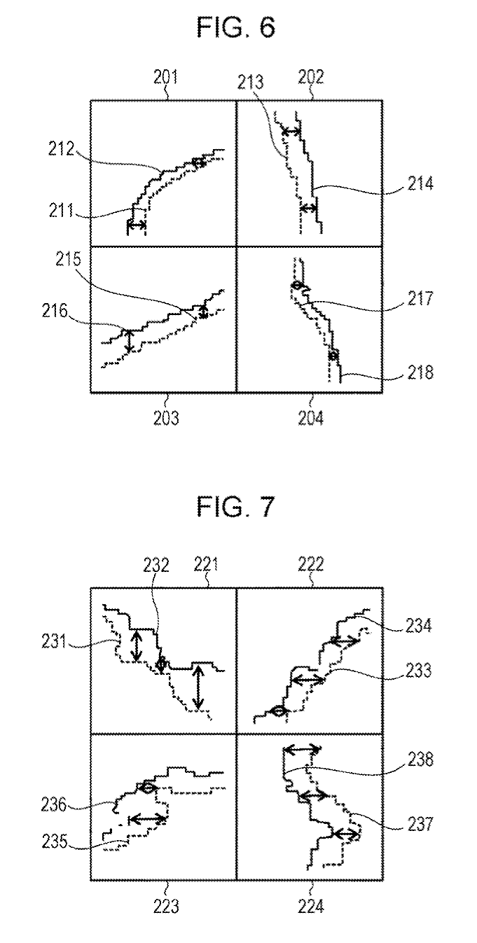

For example, FIG. 6 illustrates an example of inner boundaries and outer boundaries that are detected in non-fuzzy regions in an α map for a blurred image. In regions 201 to 204, inner boundaries are indicated by dotted lines, and outer boundaries are indicated by solid lines. As illustrated in FIG. 6, for example, the shape of an inner boundary 211 and the shape of an outer boundary 212 in the region 201 are similar, and the change in distance between the inner boundary 211 and the outer boundary 212 is small. Thus, the spatial correlation therebetween is high. Similar relationships are also established between an inner boundary 213 and an outer boundary 214 in the region 202, between an inner boundary 215 and an outer boundary 216 in the region 203, and between an inner boundary 217 and an outer boundary 218 in the region 204.

FIG. 7 illustrates an example of inner boundaries and outer boundaries that are detected in fuzzy regions in an α map for a blurred image. In regions 221 to 224, inner boundaries are indicated by dotted lines, and outer boundaries are indicated by solid lines. As illustrated in FIG. 7, for example, the shape of an inner boundary 231 and the shape of an outer boundary 232 in the region 221 are markedly different, and the change in distance between the inner boundary 231 and the outer boundary 232 is large. Thus, the spatial correlation therebetween is low. Similar relationships are also established between an inner boundary 233 and an outer boundary 234 in the region 222, between an inner boundary 235 and an outer boundary 236 in the region 223, and between an inner boundary 237 and an outer boundary 238 in the region 224.

Thus, an inner boundary and an outer boundary in each local region in an α map can be detected and the spatial correlation value between the detected inner boundary and outer boundary can be used to determine whether the local region is a fuzzy region or not.

Referring back to FIG. 3, the sample point setting unit 113 sets sample points, which are to be processed for blur estimation, in a region (hereinafter referred to as an “estimation-target region”) other than a fuzzy region in an α map, and supplies the set sample points and the α map to the block division unit 114.

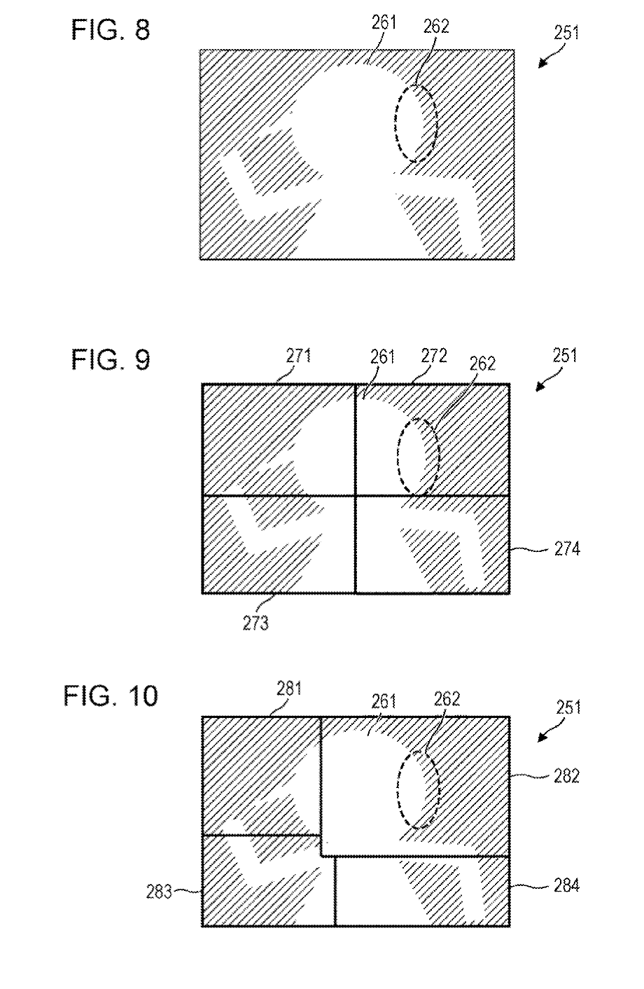

For example, consideration will be given of the setting of sample points in an α map 251 illustrated in FIG. 8. It is assumed hereinafter that an area 262 has a fuzzy region near the edge of an object 261. In the α map 251, the background portion is represented as a hatched portion.

In this case, the sample point setting unit 113 sets a region other than the fuzzy region in the area 262 as an estimation-target region, and sets sample points in the set estimation-target region.

The block division unit 114 divides the α map into n blocks so that the numbers of sample points included in the n blocks become substantially uniform. The number of blocks (n blocks) matches the number of block blur estimation units 131-1 to 131-n. The block division unit 114 supplies the α map and the positions of the sample points in each block to the corresponding one of the block blur estimation units 131-1 to 131-n of the blur estimation unit 115.

The blur estimation unit 115 is configured to include the block blur estimation units 131-1 to 131-n and an image blur estimation unit 132.

The block blur estimation units 131-1 to 131-n may be implemented by, for example, n processors having the same processing capabilities or by a (homogeneous multi-core) processor including n cores having the same processing capabilities. The block blur estimation units 131-1 to 131-n execute blur estimation on the corresponding blocks in parallel, and supply the estimation results to the image blur estimation unit 132.

The block blur estimation units 131-1 to 131-n are hereinafter referred to simply as “block blur estimation units 131” unless otherwise individually indicated.

Here, consideration will be given of a case where, for example, the number of block blur estimation units 131 is equal to four, i.e., block blur estimation units 131-1 to 131-4 are provided, and where the α map 251 illustrated in FIG. 8 is divided into four blocks.

FIG. 9 illustrates an example in which the α map 251 is equally divided into four grids. Since no sample points are set in fuzzy regions, the number of sample points in a block 272 including a fuzzy region is smaller than the number of sample points in other blocks, namely, blocks 271, 273, and 274. That is, variations occur in the number of sample points from one block to another. The variations may cause the block blur estimation unit 131-2 that estimates blur in the block 272 to complete its processing faster. Therefore, there may be a waiting time, which may prevent efficient use of the overall processing capabilities of the block blur estimation units 131.

FIG. 10 illustrates an example in which the α map 251 is divided into four blocks so that the numbers of sample points included in the blocks become substantially equal. Accordingly, the area of a block 282 including a fuzzy region is the largest, and the areas of other blocks, namely, blocks 281, 283, and 284, are substantially equal. This allows the block blur estimation units 131-1 to 131-4 to complete their blur estimation processes substantially at the same time, resulting in efficient use of the overall processing capabilities of the block blur estimation units 131.

Referring back to FIG. 3, the image blur estimation unit 132 estimates overall blur in the input image on the basis of blur estimation results in the respective blocks. The image blur estimation unit 132 outputs the estimation results to outside.

Next, a blur estimation process executed by the image processing apparatus 101 will be described with reference to a flowchart of FIG. 11. The process starts, for example, when an input image is input to the α map generation unit 111 of the image processing apparatus 101.

In step S1, the α map generation unit 111 generates an α map for the input image using a certain method. Here, the method for generating an α map is not limited to a specific method, and any suitable method may be used. The α map generation unit 111 supplies the generated α map to the boundary detection unit 121 and the sample point setting unit 113.

In step S2, the boundary detection unit 121 sets a region of interest. For example, the boundary detection unit 121 sets, as the region of interest, a local region having a certain size (for example, 32 pixels×32 pixels) at the upper left corner of the α map.

In step S3, the boundary detection unit 121 detects an inner boundary and an outer boundary in the region of interest. Specifically, the boundary detection unit 121 detects, as an inner boundary, the set of pixels satisfying α<TH1, which are detected by searching the region of interest, starting from the region satisfying α=1 (i.e., starting from the object side). That is, the boundary detection unit 121 detects, as an inner boundary, a boundary of a region including pixels satisfying α<TH1 in the region of interest when viewed from the object. The threshold TH1 may be set to, for example, 0.75.

Further, the boundary detection unit 121 detects, as an outer boundary, the set of pixels satisfying α>TH2 (where TH2≦TH1), which are detected by searching the region of interest, starting from the region satisfying α=0 (i.e., starting from the background side). That is, the boundary detection unit 121 detects, as an outer boundary, a boundary of a region including pixels satisfying α>TH2 in the region of interest when viewed from the background. The threshold TH2 may be set to, for example, 0.25.

Then, the boundary detection unit 121 supplies the detected inner boundary and outer boundary in the region of interest to the correlation value calculation unit 122.

In step S4, the correlation value calculation unit 122 calculates a spatial correlation value between the inner boundary and the outer boundary. For example, the correlation value calculation unit 122 calculates, as spatial correlation values between the inner boundary and the outer boundary, the inverse of variance in distance in the horizontal direction (hereinafter referred to as the “horizontal correlation value”) and the inverse of variance in distance in the vertical direction (hereinafter referred to as the “vertical correlation value”) between the inner boundary and the outer boundary in the region of interest. The correlation value calculation unit 122 supplies the obtained correlation values to the detection unit 123.

In step S5, the detection unit 123 determines a fuzzy region. For example, if at least one of the horizontal correlation value and the vertical correlation value is less than or equal to a certain threshold, the detection unit 123 determines that the region of interest is a fuzzy region. The detection unit 123 supplies the determination result indicating whether the region of interest is a fuzzy region or not to the sample point setting unit 113.

The method for calculating a spatial correlation value between an inner boundary and an outer boundary and the method for determining a fuzzy region based on the correlation value are not limited to those described above, and any suitable method may be used. For example, one possible method for calculating a spatial correlation value between an inner boundary and an outer boundary may be to make the origins of the inner boundary and the outer boundary match and to calculate the correlation coefficient therebetween.

In step S6, the boundary detection unit 121 determines whether any unprocessed local region remains or not. If it is determined that any unprocessed local region remains, the process returns to step S2. Then, in step S6, the processing of steps S2 to S6 is repeatedly executed until it is determined that no unprocessed local region remains.

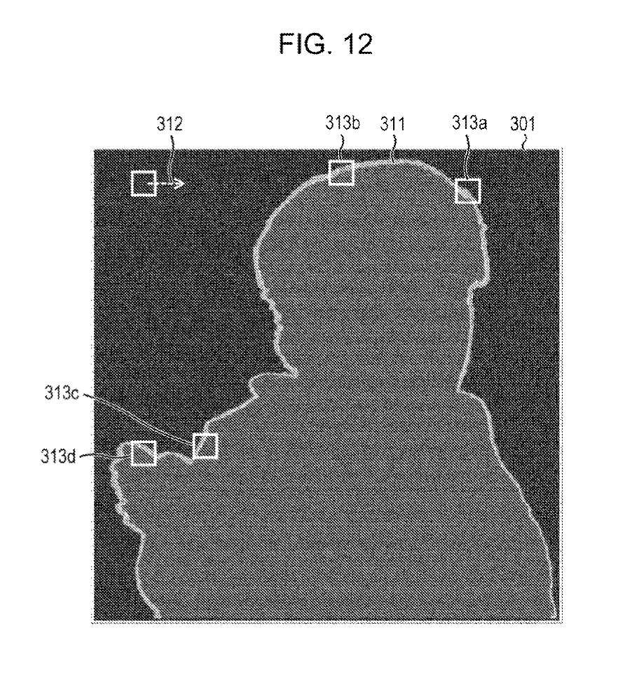

Here, consideration will be given of, for example, the processing on an α map 301 illustrated in FIG. 12. The α map 301 illustrated in FIG. 12 may be an α map for a blurred image of an object 311 that is a person, which has been captured with movement. The α map 301 is represented by a monochrome image into which an α map displayed using color temperature at which pixels with an α value of 1 are displayed in blue and pixels with an α value of 0 in red has been converted.

The processing of steps S2 to S6 is repeated to detect an inner boundary and an outer boundary in each local region of the α map 301, calculate the spatial correlation value therebetween, and determine whether the local region is a fuzzy region or not while shifting the region of interest in a manner as indicated by, for example, the arrow 312. Each local region may be set so that a portion thereof may or may not overlap an adjacent local region.

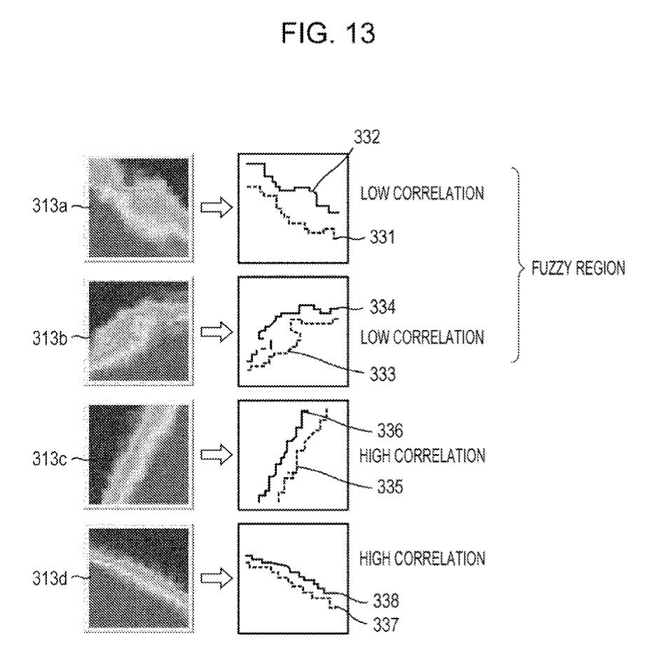

FIG. 13 is a diagram illustrating an example of inner boundaries and outer boundaries that are detected in local regions 313a to 313d illustrated in FIG. 12, and illustrating an example of results of the determination of a fuzzy region.

The local region 313a includes a head hair portion that is finer than the pixel size in the object 311, and also includes a large number of fuzzy components in addition to blur components. Therefore, the shapes of an inner boundary 331 and an outer boundary 332 in the local region 313a are markedly different, and the spatial correlation therebetween is thus low. Consequently, at least one of the horizontal correlation value and the vertical correlation value between the inner boundary 331 and the outer boundary 332 is less than or equal to a certain threshold, and therefore it is determined that the local region 313a is a fuzzy region.

Similarly, the local region 313b includes ahead hair portion of the object 311, and also includes a large number of fuzzy components in addition to blur components. Therefore, the spatial correlation between an inner boundary 333 and an outer boundary 334 in the local region 313b is low, and therefore it is determined that the local region 313b is a fuzzy region.

In contest, the local region 313c is a region including a region near the edge of clothes of the object 311, and does not substantially include portions finer than the pixel size in the object 311. That is, the local region 313c includes blur components but does not substantially include fuzzy components. Therefore, the shapes of an inner boundary 335 and an outer boundary 336 in the local region 313c are similar, and the spatial correlation therebetween is thus high. Consequently, both the horizontal correlation value and the vertical correlation value between the inner boundary 335 and the outer boundary 336 are greater than the certain threshold, and therefore it is determined that the local region 313c is not a fuzzy region.

The local region 313d is a region including a portion near the edge of the palm of the object 311, and does not substantially include portions finer than the pixel size in the object 311, like the local region 313c. That is, the local region 313d includes blur components but does not substantially include fuzzy components. Therefore, the shapes of an inner boundary 337 and an outer boundary 338 in the local region 313d are similar, and the spatial correlation therebetween is thus high. Consequently, it is determined that the local region 313d is not a fuzzy region.

Referring back to FIG. 11, if it is determined in step S6 that no unprocessed local region remains, the process proceeds to step S7.

In step S7, the sample point setting unit 113 sets sample points to be processed for blur estimation. That is, the sample point setting unit 113 sets a region other than the fuzzy regions in the α map as an estimation-target region, and sets sample points in the set estimation-target region.

At this time, all the pixels in the estimation-target region may be set as sample points, or some of them may be appropriately set as sample points to increase the processing speed. When pixels to be set as sample points are selected, for example, pixels may be selected at certain intervals or in accordance with the degree of importance. When pixels to be set as sample points are selected in accordance with the degree of importance, for example, the degree of importance of pixels near the edges of the object where image blur is prone to appear may be set high so that a large number of pixels with a high degree of importance are set as sample points, and the degree of importance of pixels in the remaining portions may be set low so that a small number of pixels with a low degree of importance are set as sample points.

Then, the sample point setting unit 113 supplies the set sample points and the α map to the block division unit 114.

In step S8, the block division unit 114 divides the α map so that the numbers of sample points become substantially uniform. That is, the block division unit 114 divides the α map into n blocks, the number of which is equal to the number of block blur estimation units 131, so that the numbers of sample points included in the n blocks become substantially uniform. The block division unit 114 supplies the α map and the positions of the sample points in the respective blocks to the corresponding block blur estimation units 131.

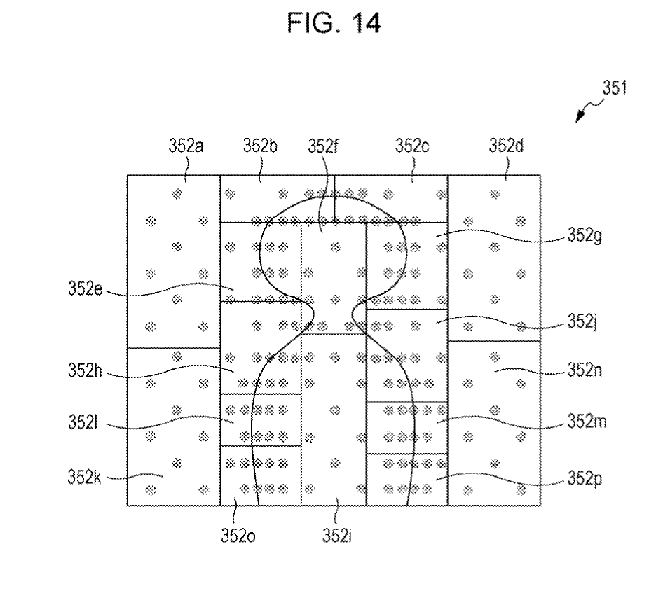

Here, a specific example of the processing of step S8 will be described with reference to FIG. 14. In FIG. 14, small dots in an α map 351 represent sample points. In the illustrated example, it is assumed that the number of block blur estimation units 131 is 16.

In this case, the block division unit 114 divides the α map 351 into 16 blocks, that is, blocks 352a to 352p, so that the numbers of sample points in the respective blocks become substantially uniform. Therefore, the size and shape of each of the blocks are adjusted in accordance with the positions and density of the sample points. Then, the block division unit 114 supplies the α map and the positions of the sample points in the respective blocks to the corresponding block blur estimation units 131.

In step S9, each of the block blur estimation unit 131 estimates image blur in the corresponding block. For example, the block blur estimation units 131 execute in parallel the process for determining the gradient of the α values at the sample points in the corresponding blocks and estimating the direction and magnitude of image blur in the corresponding blocks on the basis of the gradient of the α values at the respective sample points. The block blur estimation units 131 supply the estimation results of image blur in the corresponding blocks to the image blur estimation unit 132.

As described above, since the numbers of sample points in the respective blocks are set substantially uniform, the blur estimation processes performed by the respective block blur estimation units 131 start substantially at the same time and end substantially at the same time.

In step S10, the image blur estimation unit 132 estimates overall blur in the input image. That is, the image blur estimation unit 132 estimates the direction and magnitude of overall blur in the input image on the basis of the estimation results of image blur in the respective blocks. The image blur estimation unit 132 outputs the estimation results to outside.

The details of the process of the block blur estimation units 131 and the blur estimation unit 115 are described in, for example, Shenyang Da and Ying Wu, “Motion from blur”, IEEE CVPR, 2008, described above.

Accordingly, the blur estimation using only an estimation-target region other than a fuzzy region can eliminate or reduce the influence of fuzzy components and can improve the accuracy of blur estimation in an input image. Additionally, the improvement in the accuracy of blur estimation can increase the quality of an image subjected to blur correction by making use of the blur estimation results.

Furthermore, since block division is performed so that the numbers of sample points to be processed by the individual block blur estimation units 131 become substantially uniform, the processes of the block blur estimation units 131 can be performed optimally in parallel. Consequently, the overall processing capabilities of the block blur estimation units 131 can be efficiently used, and the processing time can be reduced.

### Second Embodiment

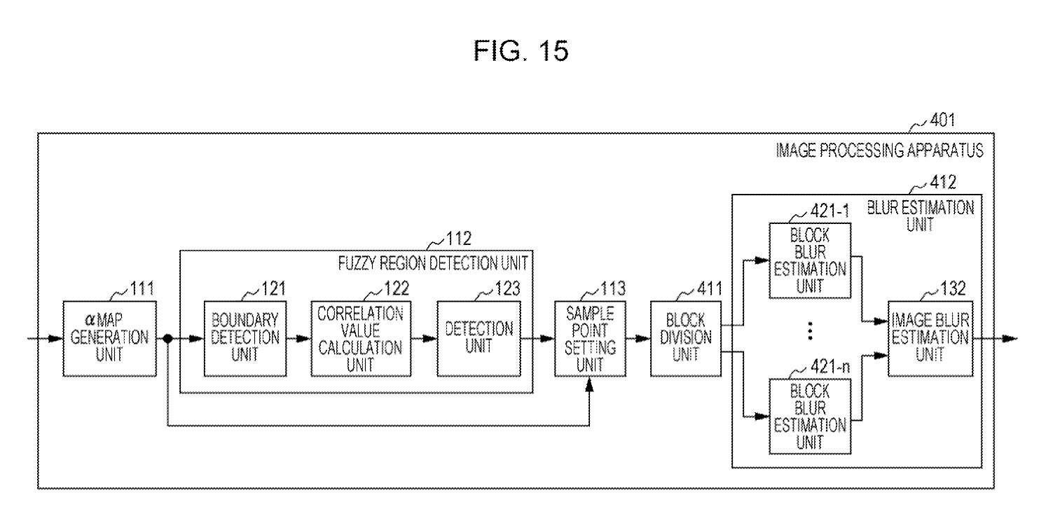

Next, a second embodiment of the present disclosure will be described with reference to FIGS. 15 to 17.

FIG. 15 is a block diagram illustrating an example configuration of an image processing apparatus 401 according to a second embodiment of the present disclosure. In FIG. 15, portions corresponding to those in FIG. 3 are assigned the same numerals, and the redundant descriptions thereof are omitted.

Like the image processing apparatus 101 illustrated in FIG. 3, the image processing apparatus 401 includes an α map generation unit 111, a fuzzy region detection unit 112, and a sample point setting unit 113. However, the image processing apparatus 401 includes a block division unit 411 and a blur estimation unit 412 in place of the block division unit 114 and the blur estimation unit 115, respectively. Further, like the blur estimation unit 115, the blur estimation unit 412 includes an image blur estimation unit 132. However, the blur estimation unit 412 includes block blur estimation unit 421-1 to 421-n in place of the block blur estimation units 131-1 to 131-n, respectively.

The block division unit 411 equally divides an α map into n blocks having the same size and shape. The number of blocks (n blocks) matches the number of block blur estimation units 421-1 to 421-n. The block division unit 411 further allocates the respective blocks to the block blur estimation units 421-1 to 421-n on the basis of the processing capabilities of the block blur estimation units 421-1 to 421-n and the number of sample points included in each of the blocks. The block division unit 411 supplies the α map and the positions of the sample points in the respective blocks to the corresponding block blur estimation units 421-1 to 421-n.

The block blur estimation units 421-1 to 421-n may be implemented by, for example, n processors having different processing capabilities or a (heterogeneous multi-core) processor including n cores having different processing capabilities. All the block blur estimation units 421-1 to 421-n may not have different processing capabilities. Specifically, the block blur estimation units 421-1 to 421-n may have at least two different types of processing capabilities, and a plurality of block blur estimation units may have the same processing capabilities. The block blur estimation units 421-1 to 421-n execute blur estimation on the corresponding blocks in parallel, and supply the estimation results to the image blur estimation unit 132.

The block blur estimation units 421-1 to 421-n are hereinafter referred to simply as “block blur estimation units 421” unless otherwise individually indicated.

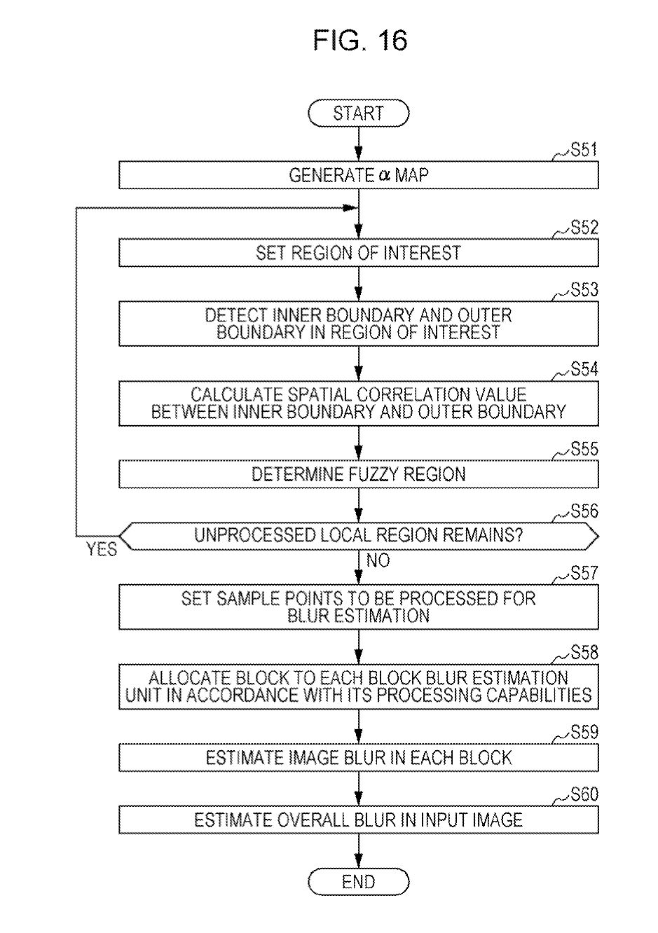

Next, a blur estimation process executed by the image processing apparatus 401 will be described with reference to a flowchart of FIG. 16. The process starts, for example, when an input image is input to the α map generation unit 111 of the image processing apparatus 401.

The processing of steps S51 to S57 is similar to the processing of steps S1 to S7 in FIG. 11, and the redundant descriptions thereof are omitted. Through the above process, a fuzzy region in an α map is detected, and sample points are set in an estimation-target region other than the fuzzy region.

In step S58, the block division unit 411 allocates the blocks to the respective block blur estimation units 421 in accordance with their processing capabilities.

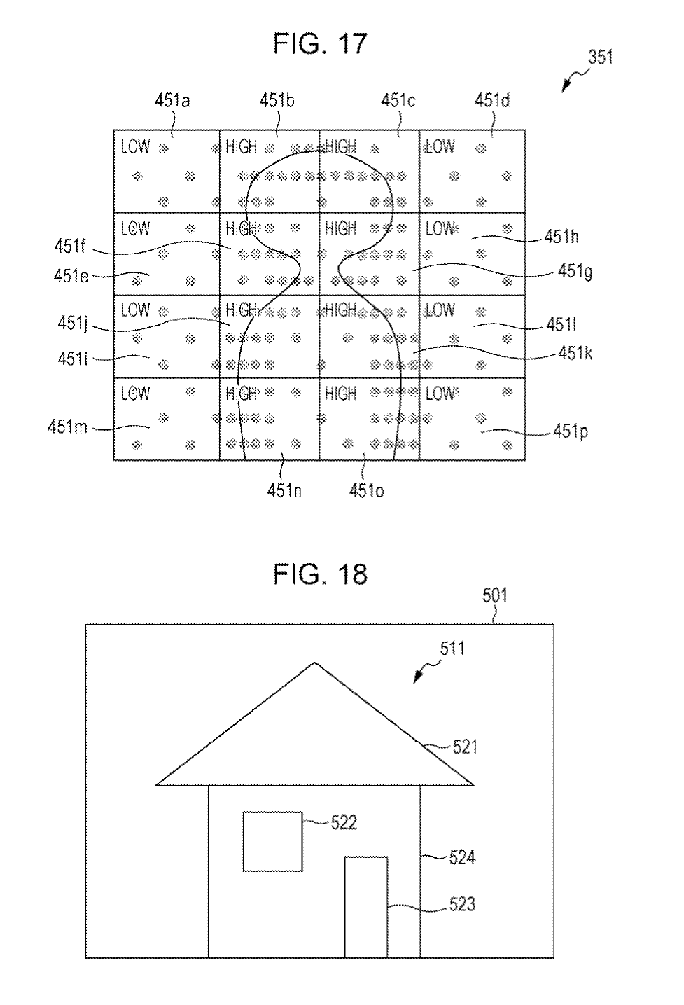

Here, a specific example of the processing of step S58 will be described with reference to FIG. 17. In FIG. 17, an α map 351 is substantially the same as the α map 351 illustrated in FIG. 14, and sample points are set at substantially the same positions. In the illustrated example, furthermore, it is assumed that the number of block blur estimation units 421 is 16 and that the block blur estimation units 421-1 to 421-3 have higher processing capabilities than the block blur estimation units 421-9 to 421-16.

First, the block division unit 411 equally divides the α map 351 into 16 blocks, namely, blocks 451a to 451p. Then, the block division unit 411 allocates blocks having a larger number of sample points to the block blur estimation units 421 having higher processing capabilities, and allocates blocks having a smaller number of sample points to block blur estimation units 421 having lower processing capabilities. For example, the block division unit 411 allocates the blocks 451b, 451c, 451f, 451g, 451j, 451k, 451n, and 451o having a larger number of sample points to the block blur estimation units 421-1, 421-2, 421-3, 421-4, 421-5, 421-6, 421-7, and 421-8 having higher processing capabilities, respectively. The block division unit 411 further allocates the blocks 451a, 451d, 451e, 451h, 451i, 451l, 451m, and 451p having a smaller number of sample points to the block blur estimation units 421-9, 421-10, 421-11, 421-12, 421-13, 421-14, 421-15, and 421-16 having lower processing capabilities, respectively.

Then, the block division unit 411 supplies the α map and the positions of the sample points in the respective blocks to the corresponding block blur estimation units 421.

In step S59, each of the block blur estimation units 421 estimates image blur in the corresponding block in a manner similar to that in the processing of step S9 in FIG. 11. As described above, since the blocks are allocated to the respective block blur estimation units 421 in accordance with the processing capabilities of the block blur estimation units 421, the blur estimation processes performed by the respective block blur estimation units 131 start substantially at the same time and end substantially at the same time.

In step S60, the image blur estimation unit 132 estimates overall blur in the input image in a manner similar to the processing of step S10 in FIG. 11. Then, the blur estimation process ends.

Accordingly, blocks are allocated to the individual block blur estimation units 421 on the basis of the processing capabilities of the block blur estimation units 421 and the number of sample points in each of the blocks. Thus, the processes of the block blur estimation units 421 can be performed optimally in parallel. Consequently, the overall processing capabilities of the block blur estimation units 421 can be efficiently used, and the processing time can be reduced.

### Modifications

In the foregoing description, an α map is divided into a plurality of blocks, and blur estimation is performed on a block-by-block basis, by way of example. However, blur estimation may be performed without using block division.

Embodiments of the present disclosure may cover blur estimation using images or data other than α maps. That is, even when an image or data other than an α map is used, a fuzzy region may be detected and blur estimation may be performed in a region other than the fuzzy region, resulting in improved blur estimation accuracy.

In addition, if an object can be divided into a plurality of regions, a fuzzy region may be detected using, for example, the regions obtained as a result of division, by regarding the boundaries between the regions as the boundaries between foreground and background in an α map. For example, in FIG. 18, a house 511 that is an object in an image 501 may be divided into four regions, namely, a roof 521, a window 522, a door 523, and a wall 524, and the boundaries between the roof 521 and the wall 524, between the window 522 and the wall 524, and between the door 523 and the wall 524 may be regarded as the boundaries between foreground and background in an α map, and a fuzzy region may be detected.

The teachings of the present technology may be applied to apparatuses or software for detecting image blur, apparatuses or software for correcting image blur, and other suitable apparatuses or software. Examples of such apparatuses and software include a digital camera, a digital video camera, a camera-equipped information processing terminal (such as a mobile phone), an image display apparatus, an image reproducing apparatus, an image recording apparatus, an image recording/reproducing apparatus, and software for editing an image.

The series of processes described above can be executed by hardware or software. When the series of processes is executed by software, a program implementing the software is installed into a computer. Examples of the computer include a computer incorporated in dedicated hardware, and a general-purpose personal computer capable of executing various functions by installing various programs therein.

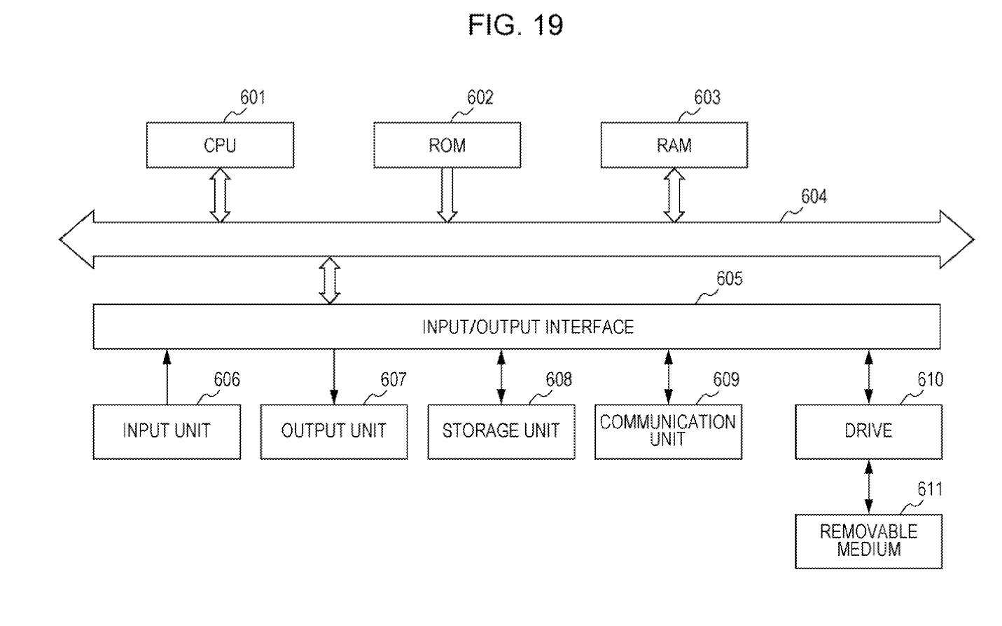

FIG. 19 is a block diagram illustrating an example configuration of hardware of a computer that executes the series of processes described above in accordance with a program.

In the computer, a central processing unit (CPU) 601, a read only memory (ROM) 602, and a random access memory (RAM) 603 are connected to one another via a bus 604.

An input/output interface 605 is also connected to the bus 604. An input unit 606, an output unit 607, a storage unit 608, a communication unit 609, and a drive 610 are further connected to the input/output interface 605.

The input unit 606 includes a keyboard, a mouse, and a microphone. The output unit 607 includes a display and speakers. The storage unit 603 includes a hard disk and a non-volatile memory. The communication unit 609 includes a network interface. The drive 610 drives a removable medium 611 such as a magnetic disk, an optical disk, a magneto-optical disk, or a semiconductor memory.

In the computer having the above configuration, the CPU 601 loads a program stored in, for example, the storage unit 608 into the RAM 603 through the input/output interface 605 and the bus 604 and executes the program. Thus, the series of processes described above is performed.

The program executed by the computer (CPU 601) may be provided in the form of being recorded on, for example, the removable medium 611 serving as a package medium. The program may also be provided through a wired or wireless transmission medium such as a local area network, the Internet, or digital satellite broadcasting.

In the computer, the program can be installed into the storage unit 608 through the input/output interface 605 by setting the removable medium 611 in the drive 610. Alternatively, the program may be received by the communication unit 609 via a wired or wireless transmission medium, and may be installed into the storage unit 608. The program may also be installed in advance in the ROM 602 or the storage unit 608.

The program executed by the computer may be a program that allows processes to be performed in a time-series manner in the order described herein, or may be a program that allows processes to be performed in parallel or at a necessary time such as when called.

Embodiments of the present disclosure are not limited to the embodiments described above, and a variety of modifications can be made without departing from the scope of the present disclosure.

The present disclosure contains subject matter related to that disclosed in Japanese Priority Patent Application JP 2010-125969 filed in the Japan Patent Office on Jun. 1, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
a boundary detection unit configured to detect an inner boundary and an outer boundary in each of local regions in an image including an object and a background, the inner boundary being a boundary between the object and the background when viewed from the object, the outer boundary being a boundary between the object and the background when viewed from the background;
a correlation value calculation unit configured to calculate a spatial correlation value between the inner boundary and the outer boundary for each of the local regions; and
a region detection unit configured to detect a local region having a correlation value less than or equal to a certain threshold among the local regions.

2. The image processing apparatus according to claim 1, further comprising:
a blur estimation unit configured to estimate image blur in an estimation-target region, the estimation-target region being a region other than the local region detected by the region detection unit.

3. The image processing apparatus according to claim 2, further comprising:
a sample point setting unit configured to set a sample point to be processed for blur estimation in the estimation-target region; and
a division unit configured to divide the image into n blocks,
wherein the blur estimation unit includes
n block blur estimation units each configured to estimate image blur in one of the blocks, and
an image blur estimation unit configured to estimate overall blur in the image in accordance with estimation results of image blur in the blocks.

4. The image processing apparatus according to claim 3, wherein the division unit divides the image into n blocks so that the numbers of sample points included in the blocks become substantially uniform.

5. The image processing apparatus according to claim 3, wherein the division unit allocates the blocks to the block blur estimation units in accordance with processing capabilities of the block blur estimation units and the number of sample points included in each of the blocks.

6. The image processing apparatus according to claim 1, wherein the image is an alpha map in which a first value, a second value, or an intermediate value between the first value and the second value is set for each unit region having a certain size in an original image in such a manner that the first value is set for a unit region included only in the object, the second value is set for a unit region included only in the background, and the intermediate value is set for a unit region included both in the object and the background in accordance with a ratio of an area of the object to an area of the background in the unit region.

7. An image processing method for an image processing apparatus, comprising:
detecting an inner boundary and an outer boundary in each of local regions in an image including an object and a background, the inner boundary being a boundary between the object and the background when viewed from the object, the outer boundary being a boundary between the object and the background when viewed from the background;
calculating a spatial correlation value between the inner boundary and the outer boundary for each of the local regions; and
detecting a local region having a correlation value less than or equal to a certain threshold among the local regions.

8. A program for causing a computer to execute a process comprising:
detecting an inner boundary and an outer boundary in each of local regions in an image including an object and a background, the inner boundary being a boundary between the object and the background when viewed from the object, the outer boundary being a boundary between the object and the background when viewed from the background;
calculating a spatial correlation value between the inner boundary and the outer boundary for each of the local regions; and
detecting a local region having a correlation value less than or equal to a certain threshold among the local regions.
